(19) United States
(12) Patent Application Publication
(10) Pub. No.: US 2024/0282150 A1
(43) Pub. Date: Aug. 22, 2024

(54) DEVICE AND METHOD FOR PROCESSING VIDEO DATA TO DETECT LIFE

(71) Applicant: UNISSEY, CHAMPS SUR MARNE (FR)

(72) Inventors: David BOUBA, CHAMPS SUR MARNE (FR); Idriss MGHABBAR, CHAMPS SUR MARNE (FR); Olivier ROBLIN, CHAMPS SUR MARNE (FR)

(73) Assignee: UNISSEY, CHAMPS SUR MARNE (FR)

(21) Appl. No.: 18/276,773

(22) PCT Filed: Feb. 15, 2022
(86) PCT No.: PCT/FR2022/050271

§ 371 Date: Mar. 29, 2024

(30) Foreign Application Priority Data
Feb. 15, 2021 (FR) FR2101447

(51) Int. Cl. G06V 40/40; G06V 10/25; G06V 10/26; G06V 10/56; G06V 10/60; G06V 10/774; G06V 10/82; G06V 20/40; G06V 40/10; G06V 40/16

(52) U.S. Cl. CPC G06V 40/45; G06V 10/25; G06V 10/26; G06V 10/56; G06V 10/60; G06V 10/774; G06V 10/82; G06V 20/46; G06V 40/15; G06V 40/171

(57) ABSTRACT

Device for analysing video data. comprising: a first analyser (6) designed to perform a remote photoplethysmography measurement on video data (25) which are to be analysed and which have been received as input, the analyser comprising a separator (20) designed to determine areas of interest (27) in the video data (25) to be analysed, an aggregator (22) designed to determine a remote photoplethysmography signal from the video data (25) to be analysed relating to each area of interest, and a computer (24) designed to calculate a spectral signal from the photoplethysmography signal and to extract one or more physiological signals (29) therefrom: a tester (8) designed to receive the one or more physiological signals (29) and to return a first human presence value: a second analyser (10) designed to receive the video data to be analysed and to apply a neural network to said data in order to extract a second human presence value therefrom, the neural network being trained using video data similar to the video data to be analysed and sets of characteristics extracted from said video data, obtained by local analysis and/or by machine learning; and a unifier (12) designed to receive the first and second human presence values and to return a unified human presence value.

The invention relates to the field of detecting human presence, or detecting life.

The rise of new technologies has led to numerous new automated or semiautomated uses, such as the authentication of persons, for authorising one or more accesses to private data/locations, guaranteeing a presence at a given place and time, etc.

These new uses pose new challenges in order to guarantee the authenticity of the identifications. Indeed, several types of attacks have been developed, whether it is by the broadcasting of a photograph or of a video of a person instead of the person that is supposed to be authenticated, the wearing of a partial or total mask, etc.

Therefore, the detection of life is a booming field, and aims in general to verify whether a person in a video is indeed a person actually filmed, and not a spoof in one of the forms mentioned above, or another form.

Solutions have been developed to try to manage these situations. For example, the document US 2016/0371555 describes a method comprising an acoustic analysis, a measurement of presence of a pulse from video data, and comparison between the measurement of presence of a pulse from video data and a physical measurement by the user wishing to be authenticated/identified.

It goes without saying that this method is extremely intrusive, and poses problems in terms of both the accessibility of the service, that is to say the possibility of implementing it, and the acceptability, and from both the legal and user point of view.

Other solutions, less intrusive, are based on the analysis of the video data alone, in order to extract characteristics from the video data and to try to detect whether it is a video filming a real person “in 3 dimensions” or a video of a video.

However, the less intrusive solutions all have the defect of being extremely vulnerable to various spoofing strategies.

Consequently, the current solutions for detecting life require making a choice between being not very intrusive and practical but not sufficiently reliable and being reliable but very impractical to implement and with legal and consent barriers.

The invention aims to improve the situation. For this purpose, it proposes a device for analysing video data, comprising:
a first analyser arranged to execute a remote photoplethysmography measurement on video data to be analysed received as an input, comprising a separator arranged to determine areas of interest in the video data to be analysed, an aggregator arranged to determine a remote photoplethysmography signal from the video data to be analysed relative to each area of interest, and a computer arranged to calculate a spectral signal from the photoplethysmography signal, and to obtain therefrom one or more physiological signals,
a tester designed to receive said one or more physiological signals and one or more out of the photoplethysmography signal and said spectral signal, and to return a first human presence value,
a second analyser arranged to receive the video data to be analysed and to apply to it a neural network to obtain therefrom a second human presence value, the neural network being trained on video data similar to the video data to be analysed and sets of characteristics extracted from this video data, obtained by local analysis and/or by machine learning, and
a unifier arranged to receive the first human presence value and the second human presence value, and to return a unified human presence value.

This device is particularly advantageous since it allows to carry out a detection of life in a manner that is not very intrusive but extremely reliable and robust against the known spoofing methods. Indeed, it is based exclusively on the analysis of the video data, which minimises its intrusive aspect. However, it does not sacrifice any reliability. Indeed, the first human presence value allows to increase the signal-to-noise ratio with to respect the known remote photoplethysmography measurements used in the detection of life, while protecting against an attack by 3D mask, partial or not. Simultaneously, the second human presence value allows to protect against the conventional attacks of video reproduction and others.

According to various embodiments, the device can have one or more of the following features:
the separator is arranged to apply one or more out of the group comprising the Haar cascades method, a deep neural network in order to determine the contours of the face in each frame of the video data, and to divide them into areas of interest in each frame,
the deep neural network is retinaface_mnet025_v2 or res10_300x300_ssd_iter_140000,
the separator is arranged to cut the video data in which the contours of the face have been determined by colorimetric analysis and/or on the basis of the recognition of a characteristic point of the face,
the aggregator is arranged to determine a remote photoplethysmography signal, for each frame, from the average of the respective R, G, B components of the video data of each area of interest,
the aggregator is further arranged to determine a remote photoplethysmography signal from a normalisation and from an infinite or finite impulse response band-pass filtering applied to the average of the respective R, G, B components of the video data of each area of interest,
the aggregator is further arranged to determine a remote photoplethysmography signal from the combination of the signals obtained from the respective R, G, B components of the video data of each area of interest,
the computer is arranged to receive the remote photoplethysmography signal and to obtain therefrom one or more physiological signals by applying a Welch algorithm or a fast Fourier transform and by obtaining therefrom one or more spectra, and by determining one or more physiological data chosen from a group comprising the cardiac rhythm, the respiratory rhythm, or the variation in cardiac frequency,
the tester is a neural network which has been trained with a database of videos labelled to indicate a human presence or not, the data provided to the input layer of this neural network being formed by the signal of physiological data determined for each of these videos,
the second analyser comprises on the one hand a neural network of the LSTM type which receives as an input facial characteristics extracted from the video data by applying an extraction of the LBP type and/or an extraction of the SURF type, and which is trained with a database of videos labelled to indicate a human presence or not, and on the other hand a deep neural network based on the MobilenetV3 or ResNext architecture comprising at the output a dense layer of neurons normalised by a layer applying the Softmax function, the main cost function being able to mix cross-entropy loss, focal loss, label softening and maximum entropy loss, and optionally one or more auxiliary cost functions based on a depth map, the rPPG signal, attributes relative to the video quality, attributes relative to the colour of the skin, and attributes relative to the type of apparatus,
the unifier is arranged to carry out an operation out of a product of the input values with weighted weights, the application of logistic regression models, a combination of the Min/max/average type, or a random forest algorithm.

The invention also relates to a device for analysing video data, comprising:
an analyser arranged to receive the video data and to apply to it a neural network to obtain therefrom deep characteristics, the neural network being trained on video data similar to the video data to be analysed and sets of characteristics extracted from this video data, obtained by local analysis and/or by machine learning,
a separator arranged to determine areas of interest in the video data to be analysed, extract characteristics of areas of interest coupled with a neural network arranged to extract facial characteristics,
an aggregator arranged to determine a remote photoplethysmography signal from the video data to be analysed relative to each area of interest and coupled with a neural network arranged to extract remote photoplethysmography characteristics,
a neural network applying a Softmax function to the deep characteristics, to the characteristics of areas of interest, to the facial characteristics and to the remote photoplethysmography characteristics to obtain therefrom a characteristic map score,
a computer arranged to calculate a remote photoplethysmography score from the data coming from the aggregator or from the separator,
an analyser arranged to calculate a luminosity score from an image processing that analyses the luminosity of the video data by seeking a colorimetric deviation in order to characterise the probability that the video data was refilmed, and
a unifier arranged to receive the characteristic map score, the photoplethysmography score and the luminosity score, and to return a unified human presence value.

The invention also relates to a method for processing video data implemented by computer, comprising receiving video data, processing it with the device according to the invention, and returning a unified human presence value, a computer program comprising instructions to implement the device according to the invention and a storage medium on which this computer program is recorded.

Finally, the invention relates to a computer program product comprising instructions for implementing the method when it is executed on a computer, and a storage medium on which the computer program product is recorded.

Other features and advantages of the invention will be clearer upon reading the following description, obtained from examples given for illustrative and non-limiting purposes, obtained from the drawings in which:

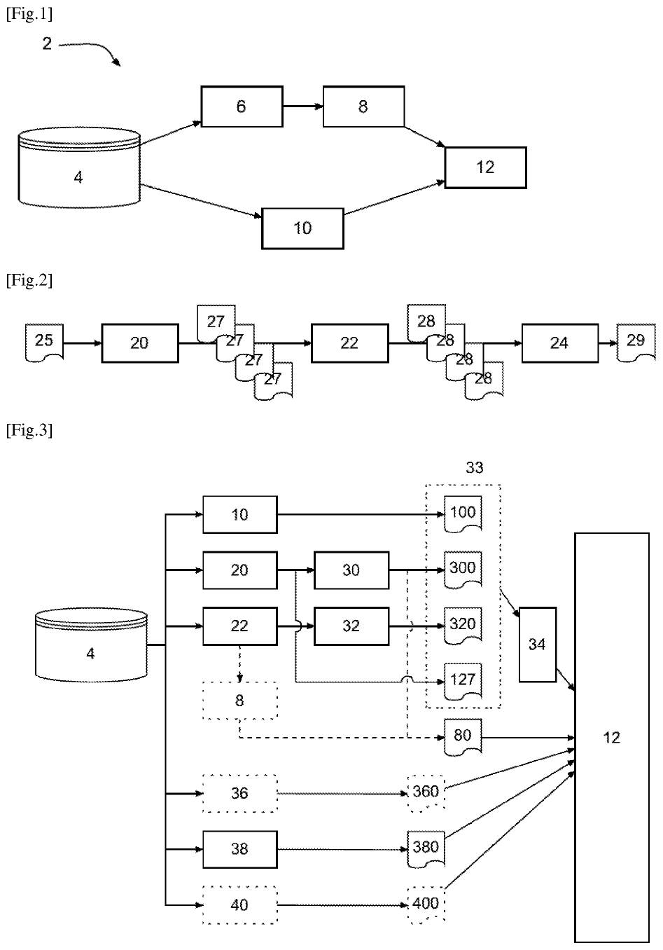

FIG. 1 shows a schematic example of a device according to the invention,

FIG. 2 shows a schematic example of the first analyser of FIG. 1, and

FIG. 3 shows an alternative embodiment of the device of FIG. 1.

The drawings and the following description contain, in essence, elements of a certain nature. They can thus not only be used to make the present invention better understood, but also contribute to its definition, if necessary.

FIG. 1 shows a schematic example of implementation of the invention. In this example, the device 2 comprises a memory 4, a first analyser 6, a tester 8, a second analyser 10 and a unifier 12.

The memory 4 can be any type of data storage suitable for receiving digital data: hard disk, flash-memory hard disk, flash memory in any form, RAM, magnetic disk, storage distributed locally or in the cloud, etc. The data calculated by the device can be stored on any type of memory similar to the memory 4, or on the latter. This data can be erased after the device has carried out its task or preserved.

In the example described here, the memory 4 receives all the data necessary for the implementation of the device 2. This data is of several natures. It can comprise parameters and/or sets of parameters for implementing the device 2 or one of the elements that it comprises, video data to be analysed and optionally video data that can be used to train one of the elements that the device 2 comprises.

The first analyser 6, the tester 8, the second analyser 10 and the unifier 12 are elements directly or indirectly accessing the memory 4. They can be produced in the form of a suitable computer code executed on one or more processors. Processors should be understood as any processor suitable for the calculations described below. Such a processor can be produced in any known manner, in the form of a microprocessor for a personal computer, a dedicated chip of the FPGA or SoC type, a calculation resource on a grid or in the cloud, a microcontroller, or any other form suitable for providing the calculation power necessary for the embodiment described below. One or more of these elements can also be produced in the form of specialised electronic circuits like an ASIC. A combination of processor and electronic circuits is also possible.

In the example described here, the first analyser 6 has the function of receiving video data to be analysed, and processing it to carry out all or a part of a remote photoplethysmography measurement (or rPPG measurement) and returning data that can be processed by the tester 8. As for the tester 8, it has a role of processing the data coming from the first analyser 6 in order to return a first human presence value that qualifies the detection of life by rPPG measurement. Alternatively, the first analyser 6 and the tester 8 can be seen as the same single entity.

As a reminder, remote photoplethysmography is a technique for optical measurement using a video stream allowing to access a cardiac signal by measuring the changes in blood volume in tissue. Indeed, for any person, a part of the incident light on the skin is absorbed by the latter. Since blood strongly absorbs visible light, the quantity of light reflected varies with the cardiac pulsation. Upon each beat of the heart, the inflow of blood in the capillary vessels and the arterioles increases the quantity of blood in the cutaneous tissue and thus the absorption of light. Inversely, when the blood flows out, the absorption of light decreases. It is these variations in the quantity of absorbed light that are responsible for subtle variations in colour, the analysis of which allows to deduce the cardiac signal, and then, various physiological data (cardiac rhythm, respiratory rhythm, HRC, etc.).

Recent research has shown that it is possible to carry out this measurement using a video stream coming from a standard camera, via computer vision and signal processing algorithms, which has given rise to remote photoplethysmography (hereinafter also designated by the acronym rPPG) , which allows to obtain at the output a signal similar to the signal measured by pulse oximeters, but remotely.

FIG. 2 shows an embodiment as an example of the first analyser 6. As visible in this figure, the latter comprises a separator 20, an aggregator 22, and a computer 24. As elements of the first analyser 6, the paragraph above relating to the means for producing them applied identically.

FIG. 2 also allows to better understand the operations executed by the first analyser 6. Thus, video data 25 received at the input of the device 2, and optionally stored in the memory 4 at least temporarily, is transmitted to the separator 20.

The separator 20 is arranged to determine areas of interest in the video data 25. In the case described here, the video data contains the face of the users seeking to be authenticated. Thus, the separator 20 applies conventional algorithms such as the Haar cascades method, a deep neural network (or DNN) such as retinaface_mnet025_v2 or res10_300×300_ssd_iter_140000 in order to first determine the contours of the face in each frame of the video data 25, then by dividing said face into several areas identified here again in each frame, in particular by detecting the variations in the skin of the face. The detection of skin can be carried out by colorimetric analysis (based on the probability that a pixel colour is of the skin, obtained according to several possible methods) , based on the recognition of a characteristic point of the face (eyes, nose, contours, etc.), or by combining the two (extending the colour of a particular zone, nose for example, and eliminating the eyes and the mouth). The result lies in a set of data of areas of interest 27 that each contain the video data of the video data 25 relative to a particular area of interest identified by the separator 20.

Then, the aggregator 22 works on each of the data of areas of interest 28 in order to prepare the latter to obtain therefrom an rPPG signal. In a preferred embodiment, the aggregator 22 carries out one or more of the following operations:
for each frame, averaging the respective R, G, B components of the video data of areas of interest 27, which gives 3 time signals for each of the video data of area of interests 27,
optionally, normalising and filtering the 3 time signals via an infinite or finite impulse response band-pass filter to avoid phase distortion,
optionally, combining the resulting 3 time signals to produce an rPPG measurement signal 28 for each area of interest.

Finally, the computer 24 is arranged to receive all the rPPG measurement signals 28 and to obtain therefrom one or more spectra by applying the Welch algorithm or by applying a fast Fourier transform (FFT), and to determine one or more physiological data, such as the cardiac rhythm, the respiratory rhythm, HRV (variability of the cardiac frequency).

The output of the computer 24 is a physiological data signal 29 that is transmitted to the tester 8 in order to calculate a first human presence value. In the example described here, the tester 8 is implemented via a neural network that has been trained with a database of videos labelled “spoof” or “life”, and for which the data provided to the input layer is formed by the physiological data signal 29 determined for each of these videos. This neural network can be a model that works on the spectrum (one-dimensional CNN or bidimensional CNN), or a model that works on the spatio-temporal signals coming from each of the subzones determined above, each subzone providing either a mixed time signal, or three signals R, G, B or six signals R, G, B, Y, U, V. The architecture of this neural network is inspired by the model ResNet 18 (18 layers) (https://arxiv.org/pdf/1512.03385.pdf). The loss function estimates the error (MAE for “Mean Absolute Error” or RMSE for “Root Mean Squared Error”) on the cardiac rhythm.

In the example described here, the first human presence detection value at the output of the tester 8 can be a score between two extrema, one of which is associated with a spoof and the other with a detection of life. Alternatively, the output can be a Boolean indicating either a spoof, or a detection of life. Alternatively, the tester 8 can be carried out via a “conventional” algorithm, which processes the physiological data signal 29 to calculate a score for the corresponding video data to be analysed 25. Such a score can be comprised between two extrema, one of which is associated with a spoof and the other with a detection of life. Alternatively, the output can be a Boolean indicating either a spoof, or a detection of life. For example, upon each update of the models, a set of test data can be used to define a threshold such that, in the set of test data, all the attacks are detected (that is to say the case in which a video to be analysed does not correspond to the presence of a person).

In the example described here, the function of the second analyser 10 is to receive video data 25 to be analysed, and to analyse the latter by carrying out an extraction of characteristics allowing to determine whether it is video data taken from a 3D image or whether it is a video of a 2D image (thus typically a spoof).

In the example described here, the second analyser 10 implements an extraction of data of the face to isolate this data in the video data 25, in a manner similar to that which is carried out in the first analyser 6, then the determination on the one hand of characteristics called “conventional” in the face data and characteristics coming from a deep learning in the video data 25.

The conventional characteristics can be obtained by implementing an extraction of the LBP (for Local Binary Pattern) type. In this type of extraction, the characteristics of the “local binary patterns” type encode the distribution of the binary differences of each of the pixels with respect to its neighbouring pixels. The final representation that is obtained therefrom is thus a discrete distribution (histogram) that allows the use of a machine learning model of the “random forest” or SVM (for Support Vector Machine) type. Alternatively or in addition, an extraction of the SURF (Speeded Up Robust Features) type, which encodes points of interest (orientation, intensity) at various locations in the image, thus allows to obtain a robust representation. For example, the points of interest selected can be those identified for a face. This extraction is of particular interest since the research of the applicant has revealed that the reflections induced by the 2D nature of spoofs tend to generate noisy points of interest non-localised to the expected locations of the eye, mouth, etc. type, contrary to what occurs in “real” videos. By combining these two types of extractions, the conventional characteristics obtained can be further enriched, for example with characteristics coming from temporal correlations between various zones of the face (example: division into 25 zones).

The characteristics coming from a deep learning are obtained by training a neural network according to an architecture similar to that of MobilenetV3 (https://arxiv.org/pdf/1905.02244.pdf) or that ResNext (https://arxiv.org/pdf/1611.05431.pdf) using the database ImageNet (http://www.image-net. org), then by specialising the neural network obtained by using the database that is used to train the tester 8. Thus, the resulting neural network can be used to extract characteristics coming from a deep learning from the video data 25 to be analysed.

The conventional characteristics are then used by a neural network of the LSTM (Long Short Term Memory) type to determine a first score for the second human presence detection value. The learning of this neural network can be based on the use of a cost function of the cross entropy type. The work of the applicant has shown that this type of neural network has better performance than models of the random forest/gradient-boosting/SVM type since it allows to learn the dependencies between the frames of the same video.

The characteristics coming from a deep learning are processed via a dense layer of neurons normalised by a layer applying the Softmax function (function applying a logistic regression on several classes in order to attribute decimal probabilities to each class of a problem with several classes, the sum of the probabilities being equal to 1, with the average of the characteristics of the frames of the video data 25 to be analysed as an input). This neural network can be trained with a main cost function that can mix cross-entropy loss, focal loss, label softening and maximum entropy loss, and optionally one or more auxiliary cost functions based on a depth map, signal, attributes relative to the video quality, attributes relative to the colour of the skin, and attributes relative to the type of apparatus.

The second analyser 10 can thus return on the one hand the value returned for the conventional characteristics and on the other hand the value returned for the characteristics coming from a deep learning or a combination of the two.

Thus the second human presence detection value can be a pair or a composition of these values.

Finally, the unifier 12 carries out a product of the input values with weighted weights. Alternatively, it would be possible to use logistic regression models, a combination of the Min/max/average type, or a random forest algorithm. The result returned is a unified human presence value.

FIG. 3 shows an example of another embodiment of the device of FIG. 1, wherein the device is designed as the aggregation of several neural networks, the goal of which is to deduce characteristics of the video signals allowing the unifier 12 to return a score.

More precisely, in this embodiment, the second analyser 10 is used to produce a set 100 of 512 characteristics and the separator 20 is used on the one hand to supply a neural network 30 of the RhythmNet (https://arxiv.org/pdf/1910.11515.pdf) type to extract another set 300 of 512 characteristics, and on the other hand to define a set 127 comprising 128 characteristics obtained from the data of areas of interests 27. Alternatively, the neural network 30 can be replaced by a model of the ResNext 18 type. Finally, the aggregator 22 is used to supply a correlator 32 that determines a set 320 of 256 characteristics from the correlations between the complete rPPG signals.

The set of characteristics 100, the set of characteristics 127, the set of characteristics 300 and the set of characteristics 320 together form a map of characteristics 33 that is processed by a dense layer of neurons normalised by a layer applying the Softmax 34 function, which returns a characteristic map score to the unifier 12.

In parallel, the device 2 further comprises:
an optional analyser 36 that comprises a neural network that analyses the moiré of the video in order to characterise the probability that the video was refilmed, and which produces a moiré score 360,
an analyser 38 which comprises a conventional image processing which analyses the luminosity of the video in order to characterise the probability that the video was refilmed by seeking a colorimetric deviation, and which produces a luminosity score 360, and
an optional analyser 40 that comprises a neural network which analyses the blur of the video in order to characterise the probability that the video was refilmed, and which produces a blur score 400.

The moiré score 360, the luminosity score 380 and the blur score 400 are also sent to the unifier 12, with an rPPG score 80 which can come from the tester 8 or from the neural network 30.

Finally, the unifier 12 functions in a similar manner to that of FIG. 1, and processes all the scores that are transmitted to it to return a unified human presence value.

1. Device for analysing video data, comprising:
a first analyser arranged to execute a remote photoplethysmography measurement on video data to be analysed received as an input, comprising a separator arranged to determine areas of interest in the video data to be analysed, an aggregator arranged to determine a remote photoplethysmography signal from the video data to be analysed relative to each area of interest, and a computer arranged to calculate a spectral signal from the photoplethysmography signal, and to obtain therefrom one or more physiological signal,
a tester arranged to receive said one or more physiological signals and to return a first human presence value,
a second analyser arranged to receive the video data to be analysed and to apply to it a neural network to obtain therefrom a second human presence value, the neural network being trained on video data similar to the video data to be analysed and sets of characteristics extracted from this video data, obtained by local analysis and/or by machine learning, and
a unifier arranged to receive the first human presence value and the second human presence value, and to return a unified human presence value.

2. Device according to claim 1, wherein the separator is arranged to apply one or more out of the group comprising the Haar cascades method, a deep neural network in order to determine the contours of the face in each frame of the video data, and to divide them into areas of interest in each frame.

3. Device according to claim 2, wherein the deep neural network is retinaface_mnet025_v2 or res10_300×300_ssd_iter_140000.

4. Device according to claim 2, wherein the separator is arranged to cut the video data in which the contours of the face have been determined by colorimetric analysis and/or on the basis of the recognition of a characteristic point of the face.

5. Device according to claim 1, wherein the aggregator is arranged to determine a remote photoplethysmography signal, for each frame, from the average of the respective R, G, B components of the video data of each area of interest.

6. Device according to claim 5, wherein the aggregator is further arranged to determine a remote photoplethysmography signal from a normalisation and from an infinite or finite impulse response band-pass filtering applied to the average of the respective R, G, B components of the video data of each area of interest.

7. Device according to claim 5, wherein the aggregator is further arranged to determine a remote photoplethysmography signal from the combination of the signals obtained from the respective R, G, B components of the video data of each area of interest.

8. Device according to claim 1, wherein the computer is arranged to receive the remote photoplethysmography signal and to obtain therefrom one or more physiological signals by applying a Welch algorithm or a fast Fourier transform and by obtaining one or more spectra, and by determining one or more physiological data chosen from a group comprising the cardiac rhythm, the respiratory rhythm, or the variation in cardiac frequency.

9. Device according to claim 1, wherein the tester is a neural network which has been trained with a database of videos labelled to indicate a human presence or not, the data provided to the input layer of this neural network being formed by the physiological data signal determined for each of these videos.

10. Device according to claim 1, wherein the second analyser comprises on the one hand a neural network of the LSTM type which receives as an input facial characteristics extracted from the video data by applying an extraction of the LBP type and/or an extraction of the SURF type, and which is trained with a database of videos labelled to indicate a human presence or not, and on the other hand a deep neural network based on the MobilenetV3 or ResNext architecture comprising at the output a dense layer of neurons normalised by a layer applying the Softmax function, the main cost function being able to mix cross-entropy loss, focal loss, label softening and maximum entropy loss, and optionally one or more auxiliary cost functions based on a depth map, the rPPG signal, attributes relative to the video quality, attributes relative to the colour of the skin, and attributes relative to the type of apparatus.

11. Device according to claim 1, wherein the unifier is arranged to carry out an operation out of a product of the input values with weighted weights, the application of logistic regression models, a combination of the Min/max/average type, or a random forest algorithm.

12. Device for analysing video data, comprising:
an analyser arranged to receive the video data and to apply to it a neural network to obtain therefrom deep characteristics, the neural network being trained on video data similar to the video data to be analysed and sets of characteristics extracted from this video data, obtained by local analysis and/or by machine learning,
a separator arranged to determine areas of interest in the video data to be analysed, extract characteristics of areas of interest coupled with a neural network arranged to extract facial characteristics,
an aggregator arranged to determine a remote photoplethysmography signal from the video data to be analysed relative to each area of interest and coupled with a neural network arranged to extract remote photoplethysmography characteristics,
a neural network applying a Softmax function to the deep characteristics, to the characteristics of areas of interest, to the facial characteristics and to the remote photoplethysmography characteristics to obtain therefrom a characteristic map score,
a computer arranged to calculate a remote photoplethysmography score from the data coming from the aggregator or from the separator,
an analyser arranged to calculate a luminosity score from an image processing that analyses the luminosity of the video data by seeking a colorimetric deviation in order to characterise the probability that the video data was refilmed, and
a unifier arranged to receive the characteristic map score, the remote photoplethysmography score and the luminosity score, and to return a unified human presence value.

13. Computer program comprising instructions to implement the device according to claim 1.

14. Storage medium on which the computer program according to claim 13 is recorded.

15. Method implemented by computer comprising receiving video data, processing them with the device according to claim 1, and returning a unified human presence value.
